(19) United States
(12) Patent Application Publication
(10) Pub. No.: US 2018/0083488 A1
(43) Pub. Date: Mar. 22, 2018

(54) METHODS AND APPARATUS FOR WIRELESS POWER AND COMMUNICATION TRANSFER

(71) Applicant: QUALCOMM Incorporated, San Diego, CA (US)

(72) Inventor: Paolo Menegoli, San Jose, CA (US)

(21) Appl. No.: 15/273,546

(22) Filed: Sep. 22, 2016

(51) Int. Cl. H02J 50/12; H02J 50/27; H02J 50/80; H02J 7/02

(52) U.S. Cl. CPC H02J 50/12; H02J 7/025; H02J 50/80; H02J 50/27

(57) ABSTRACT

Aspects of this disclosure include apparatus and methods for receiving power wirelessly and communicating wirelessly at low power levels. One aspect of an apparatus that wirelessly receives power may be characterized by an impedance having a reactance component and the apparatus comprises an antenna circuit, and a control circuit. The antenna circuit is configured to receive inductive power from a magnetic field generated by a power transmitter. The antenna circuit is also configured to communicate with the power transmitter. The control circuit is coupled to the antenna circuit and is configured to vary the reactance component of the impedance to a level sufficient for allowing detection as communication from the antenna circuit by the power transmitter.

### BACKGROUND

### Field of the Invention

The present disclosure relates generally to wireless power transfer and communication. More specifically, this disclosure relates to methods and apparatus for wirelessly communicating via electronic devices that may have small power storage units and/or small antennas (e.g., smart watches, mobile phones, compact fitness wearable devices, implantable devices, etc.).

### Description of the Related Art

Electronic devices may have small power storage units (e.g., batteries) and/or small antennas that provide poor inductive coupling. Accordingly, these electronic devices may not have any power or small amounts of power available when they are placed on a wireless charging device. Additionally, the small antennas and poor coupling of the electronic devices may mean that a smaller amount of power is transferred in a given power transfer instance (e.g., power beacon). Accordingly, when the electronic device is placed on the charging device, the electronic device may have insufficient power to communicate with the charging device to initiate charging procedures. Furthermore, the electronic device may be unable to communicate with the charging device to request additional power beacons due to the lack of power at the electronic device. Thus, there is a need for methods and apparatus for enabling the electronic devices having no or low power levels to effectively and efficiently communicate with the charging device with minimal power expenditures.

### SUMMARY

Various implementations of methods and devices within the scope of the appended claims each have several aspects, no single one of which is solely responsible for the desirable attributes described herein. Without limiting the scope of the appended claims, some prominent features are described herein.

An aspect of this disclosure is an apparatus for receiving power wirelessly. The apparatus may be characterized by an impedance having a reactance component and the apparatus comprises an antenna circuit, and a control circuit. The antenna circuit is configured to receive inductive power from a magnetic field generated by a power transmitter. The antenna circuit is also configured to communicate with the power transmitter. The control circuit is coupled to the antenna circuit and is configured to vary the reactance component of the impedance to a level sufficient for allowing detection as communication from the antenna circuit by the power transmitter.

An aspect of this disclosure is a method for receiving power wirelessly. The method is performed by an apparatus characterized by an impedance having a reactance component. The method comprises receiving inductive power from a magnetic field generated by a power transmitter. The method further comprises varying the reactance component of the impedance to a level sufficient for allowing detection of the varying as communication by the power transmitter. The method also comprises communicating with the power transmitter via varying the reactance component of the impedance.

Another aspect of this disclosure is another apparatus for receiving wireless power.

The apparatus is also characterized by an impedance having a reactance component. The apparatus comprises means for receiving inductive power from a magnetic field generated by a power transmitter. The apparatus also comprises means for varying the reactance component of the impedance to a level sufficient for allowing detection of the varying as communication by the power transmitter. The apparatus further comprises means for communicating with the power transmitter.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims.

FIG. 1 is a functional block diagram of a wireless power transfer system, in accordance with one exemplary implementation.

FIG. 2 is a functional block diagram of a wireless power transfer system, in accordance with another exemplary implementation.

FIG. 3 is a schematic diagram of a portion of transmit circuitry or receive circuitry of FIG. 2 including a transmit or receive antenna, in accordance with exemplary implementations.

FIG. 4 is a simplified functional block diagram of a transmitter that may be used in an inductive power transfer system, in accordance with exemplary implementations of the invention.

FIG. 5 is a simplified functional block diagram of a receiver that may be used in the inductive power transfer system, in accordance with exemplary implementations of the invention.

FIG. 6 is an example of a charging system comprising an electronic device placed on a wireless power charger.

FIG. 7 is a simplified functional block diagram of the receiver of the electronic device if FIG. 6 receiving wireless power from a field generated by the charging device (not shown) of FIG. 6, in accordance with exemplary implementations of the invention.

FIG. 8 is a schematic diagram of the functional block diagram of the receiver of FIG. 7, in accordance with exemplary implementations of the invention.

FIG. 9 is a set of three graphs of an input power of the charging device of FIG. 6 as a function of time, reactance X as seen by the charging device as a function of time, and rectified voltage of the receiver of FIG. 7 as a function of time, respectively, in accordance with exemplary implementations of the invention.

FIG. 10 is a set of three graphs of an input power of the charging device of FIG. 6 as a function of time, rectified voltage of the receiver of FIG. 7 as a function of time, and reactance X as seen by the charging device as a function of time, respectively, in accordance with exemplary implementations of the invention.

FIG. 11 is a flowchart includes a plurality of steps of a method of adjusting a reactance X of the receiver as seen by the transmitter to a level sufficient for the transmitter to detect a reactance X change as an in-band communication, in accordance with exemplary implementations of the invention.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary implementations and is not intended to represent the only implementations in which the invention may be practiced. The term “exemplary” used throughout this description means “serving as an example, instance, or illustration,” and should not necessarily be construed as preferred or advantageous over other exemplary implementations. The detailed description includes specified details for the purpose of providing a thorough understanding of the exemplary implementations. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

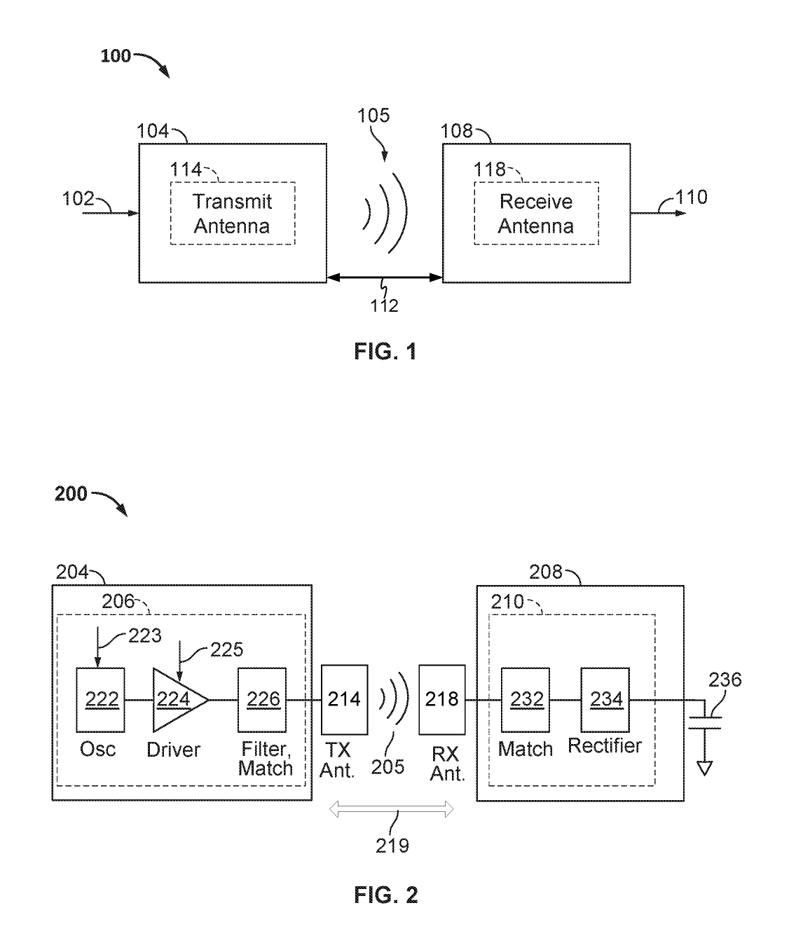

FIG. 1 is a functional block diagram of a wireless power transfer system 100, in accordance with one exemplary implementation. Input power 102 may be provided to a transmitter 104 from a power source (not shown) to generate a wireless (e.g., magnetic or electromagnetic) field 105 for performing wireless power transfer. A receiver 108 may couple to the wireless field 105 and generate output power 110 for storage or consumption by a device (not shown) coupled to the output power 110. Both the transmitter 104 and the receiver 108 are separated by a distance 112.

In one exemplary implementation, the transmitter 104 and the receiver 108 are configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over a larger distance in contrast to purely inductive solutions that may require large antenna coils which are very close (e.g., sometimes within millimeters). Resonant inductive coupling techniques may thus allow for improved efficiency and power transfer over various distances and with a variety of inductive coil configurations.

The receiver 108 may receive power when the receiver 108 is located in the wireless field 105 produced by the transmitter 104. The wireless field 105 corresponds to a region where energy output by the transmitter 104 may be captured by the receiver 108. The wireless field 105 may correspond to the “near-field” of the transmitter 104 as will be further described below. The wireless field 105 may also operate over a longer distance than is considered “near field.” The transmitter 104 may include a transmit antenna 114 (e.g., a coil) for transmitting energy to the receiver 108. The receiver 108 may include a receive antenna or coil 118 for receiving or capturing energy transmitted from the transmitter 104. The near-field may correspond to a region in which there are strong reactance fields resulting from the currents and charges in the transmit antenna 114 that minimally radiate power away from the transmit antenna 114. The near-field may correspond to a region that is within about one wavelength (or a fraction thereof) of the transmit antenna 114.

FIG. 2 is a functional block diagram of a wireless power transfer system 200, in accordance with another exemplary implementation. The system 200 includes a transmitter 204 and a receiver 208. The transmitter 204 may include a transmit circuitry 206 that may include an oscillator 222, a driver circuit 224, and a filter and matching circuit 226. The oscillator 222 may be configured to generate a signal at a desired frequency that may be adjusted in response to a frequency control signal 223. The oscillator 222 may provide the oscillator signal to the driver circuit 224. The driver circuit 224 may be configured to drive the transmit antenna 214 at, for example, a resonant frequency of the transmit antenna 214 based on an input voltage signal (VD) 225. The driver circuit 224 may be a switching amplifier configured to receive a square wave from the oscillator 222 and output a sine wave. For example, the driver circuit 224 may be a class E amplifier.

The filter and matching circuit 226 may filter out harmonics or other unwanted frequencies and match the impedance of the transmitter 204 to the impedance of the transmit antenna 214. As a result of driving the transmit antenna 214, the transmit antenna 214 may generate a wireless field 205 to wirelessly output power at a level sufficient for charging a battery 236.

The receiver 208 may include a receive circuitry 210 that may include a matching circuit 232 and a rectifier circuit 234. The matching circuit 232 may match the impedance of the receive circuitry 210 to the receive antenna 218. The rectifier circuit 234 may generate a direct current (DC) power output from an alternate current (AC) power input to charge the battery 236, as shown in FIG. 2. The receiver 208 and the transmitter 204 may additionally communicate on a separate communication channel 219 (e.g., Bluetooth, ZigBee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236.

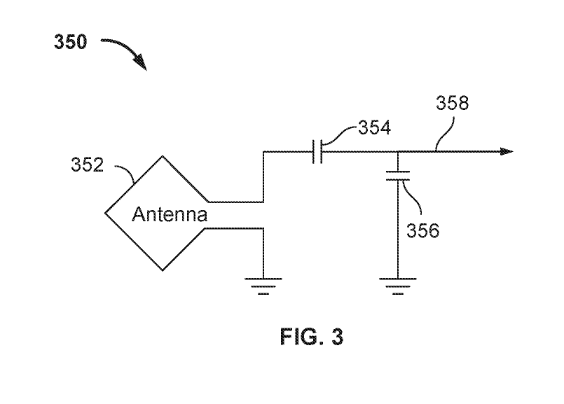

FIG. 3 is a schematic diagram of a portion of the transmit circuitry 206 or the receive circuitry 210 of FIG. 2 including a transmit or receive antenna, in accordance with exemplary implementations. As illustrated in FIG. 3, a transmit or receive circuitry 350 may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna may also be referred to as a coil of a type that is configured to wirelessly output or receive power. As used herein, the antenna 352 is an example of a “power transfer component” of a type that is configured to wirelessly output and/or receive power.

The antenna 352 may include an air core or a physical core such as a ferrite core (not shown).

The transmit or receive circuitry 350 may form/include a resonant circuit. The resonant frequency of the loop or magnetic antennas is based on the inductance and capacitance. Inductance may be simply the inductance created by the antenna 352, whereas, capacitance may be added to the antenna's inductance to create a resonant structure at a desired resonant frequency. As a non-limiting example, a capacitor 354 and a capacitor 356 may be added to the transmit or receive circuitry 350 to create a resonant circuit. For a transmit circuitry, a signal 358 may be an input at a resonant frequency to cause the antenna 352 to generate a wireless field 105/205. For receive circuitry, the signal 358 may be an output to power or charge a load (not shown). For example, the load may comprise a wireless device configured to be charged by power received from the wireless field.

Other resonant circuits formed using other components are also possible. As another non-limiting example, a capacitor may be placed in parallel between the two terminals of the circuitry 350.

Referring to FIGS. 1 and 2, the transmitter 104/204 may output a time varying magnetic (or electromagnetic) field with a frequency corresponding to the resonant frequency of the transmit antenna 114/214. When the receiver 108/208 is within the wireless field 105/205, the time varying magnetic (or electromagnetic) field may induce a current in the receive antenna 118/218. As described above, if the receive antenna 118/218 is configured to resonate at the frequency of the transmit antenna 114/214, energy may be efficiently transferred. The AC signal induced in the receive antenna 118/218 may be rectified as described above to produce a DC signal that may be provided to charge or to power a load.

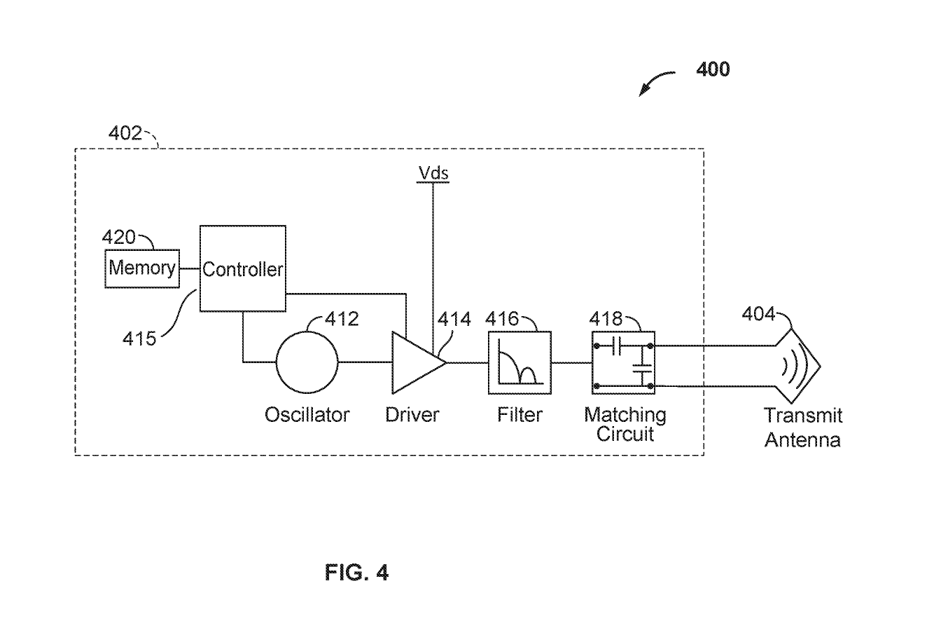

FIG. 4 is a simplified functional block diagram of a transmitter that may be used in an inductive power transfer system, in accordance with exemplary implementations of the invention. As shown in FIG. 4, the transmitter 400 includes transmit circuitry 402 and a transmit antenna 404 operably coupled to the transmit circuitry 402. The transmit antenna 404 may be configured as the transmit antenna 214 as described above in reference to FIG. 2. In some implementations, the transmit antenna 404 may be a coil (e.g., an induction coil). In some implementations, the transmit antenna 404 may be associated with a larger structure, such as a table, mat, lamp, or other stationary configuration. The transmit antenna 404 may be configured to generate an electromagnetic or magnetic field. In an exemplary implementation, the transmit antenna 404 may be configured to transmit power to a receiver device within a charging region at a power level sufficient to charge or power the receiver device.

The transmit circuitry 402 may receive power through a number of power sources (not shown). The transmit circuitry 402 may include various components configured to drive the transmit antenna 404. In some exemplary implementations, the transmit circuitry 402 may be configured to adjust the transmission of wireless power based on the presence and constitution of the receiver devices as described herein. As such, the transmitter 400 may provide wireless power efficiently and safely.

The transmit circuitry 402 may further include a controller 415. In some implementations, the controller 415 may be a micro-controller. In other implementations, the controller 415 may be implemented as an application specified integrated circuit (ASIC). The controller 415 may be operably connected, directly or indirectly, to each component of the transmit circuitry 402. The controller 415 may be further configured to receive information from each of the components of the transmit circuitry 402 and perform calculations based on the received information. The controller 415 may be configured to generate control signals for each of the components that may adjust the operation of that component. As such, the controller 415 may be configured to adjust the power transfer based on a result of the calculations performed by it.

The transmit circuitry 402 may further include a memory 420 operably connected to the controller 415. The memory 420 may comprise random access memory (RAM), electrically erasable programmable read only memory (EEPROM), flash memory, or non-volatile RAM. The memory 420 may be configured to temporarily or permanently store data for use in read and write operations performed by the controller 415. For example, the memory 420 may be configured to store data generated as a result of the calculations of the controller 415. As such, the memory 420 allows the controller 415 to adjust the transmit circuitry 402 based on changes in the data over time.

The transmit circuitry 402 may further include an oscillator 412 operably connected to the controller 415. The oscillator 412 may be configured as the oscillator 222 as described above in reference to FIG. 2. The oscillator 412 may be configured to generate an oscillating signal (e.g., radio frequency (RF) signal) at the operating frequency of the wireless power transfer. In some exemplary implementations, the oscillator 412 may be configured to operate at the 6.78 MHz ISM frequency band. The controller 415 may be configured to selectively enable the oscillator 412 during a transmit phase (or duty cycle). The controller 415 may be further configured to adjust the frequency or a phase of the oscillator 412 which may reduce out-of-band emissions, especially when transitioning from one frequency to another. As described above, the transmit circuitry 402 may be configured to provide an amount of power to the transmit antenna 404, which may generate energy (e.g., magnetic flux) about the transmit antenna 404.

The transmit circuitry 402 may further include a driver circuit 414 operably connected to the controller 415 and the oscillator 412. The driver circuit 414 may be configured as the driver circuit 224 as described above in reference to FIG. 2. The driver circuit 414 may be configured to drive the signals received from the oscillator 412, as described above.

The transmit circuitry 402 may further include a low pass filter (LPF) 416 operably connected to the transmit antenna 404. The low pass filter 416 may be configured as the filter portion of the filter and matching circuit 226 as described above in reference to FIG. 2. In some exemplary implementations, the low pass filter 416 may be configured to receive and filter an analog signal of current and an analog signal of voltage generated by the driver circuit 414. The analog signal of current may comprise a time-varying current signal, while the analog signal of current may comprise a time-varying voltage signal. In some implementations, the low pass filter 416 may alter a phase of the analog signals. The low pass filter 416 may cause the same amount of phase change for both the current and the voltage, canceling out the changes. In some implementations, the controller 415 may be configured to compensate for the phase change caused by the low pass filter 416. The low pass filter 416 may be configured to reduce harmonic emissions to levels that may prevent self-jamming. Other exemplary implementations may include different filter topologies, such as notch filters that attenuate specified frequencies while passing others.

The transmit circuitry 402 may further include a fixed impedance matching circuit 418 operably connected to the low pass filter 416 and the transmit antenna 404. The matching circuit 418 may be configured as the matching portion of the filter and matching circuit 226 as described above in reference to FIG. 2. The matching circuit 418 may be configured to match the impedance of the transmit circuitry 402 (e.g., 50 ohms) to the transmit antenna 404. Other exemplary implementations may include an adaptive impedance match that may be varied based on measurable transmit metrics, such as the measured output power to the transmit antenna 404 or a DC current of the driver circuit 414. The transmit circuitry 402 may further comprise discrete devices, discrete circuits, and/or an integrated assembly of components.

Transmit antenna 404 may be implemented as an antenna strip with the thickness, width and metal type selected to keep resistance losses low.

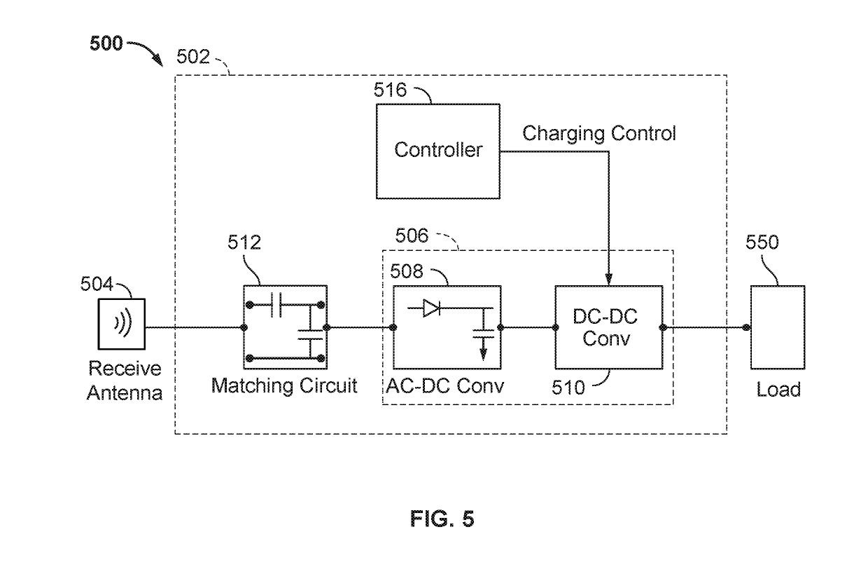

FIG. 5 is a block diagram of a receiver, in accordance with an implementation of the present invention. As shown in FIG. 5, a receiver 500 includes a receive circuitry 502, a receive antenna 504, and a load 550. The receiver 500 further couples to the load 550 for providing received power thereto. Receiver 500 is illustrated as being external to device acting as the load 550 but may be integrated into load 550. The receive antenna 504 may be operably connected to the receive circuitry 502. The receive antenna 504 may be configured as the receive antenna 218 as described above in reference to FIG. 2. In some implementations, the receive antenna 504 may be tuned to resonate at a frequency similar to a resonant frequency of the transmit antenna 404, or within a specified range of frequencies, as described above. The receive antenna 504 may be similarly dimensioned with transmit antenna 404 or may be differently sized based upon the dimensions of the load 550. The receive antenna 504 may be configured to couple to the magnetic field generated by the transmit antenna 404, as described above, and provide an amount of received energy to the receive circuitry 502 to power or charge the load 550.

The receive circuitry 502 may be operably coupled to the receive antenna 504 and the load 550. The receive circuitry may be configured as the receive circuitry 210 as described above in reference to FIG. 2. The receive circuitry 502 may be configured to match an impedance of the receive antenna 504, which may provide efficient reception of wireless power. The receive circuitry 502 may be configured to generate power based on the energy received from the receive antenna 504. The receive circuitry 502 may be configured to provide the generated power to the load 550. In some implementations, the receiver 500 may be configured to transmit a signal to the transmitter 400 indicating an amount of power received from the transmitter 400.

The receive circuitry 502 may include a processor-signaling controller 516 configured to coordinate the processes of the receiver 500 described below.

The receive circuitry 502 provides an impedance match to the receive antenna 504. The receive circuitry 502 includes power conversion circuitry 506 for converting a received energy into charging power for use by the load 550. The power conversion circuitry 506 includes an AC-to-DC converter 508 coupled to a DC-to-DC converter 510. The AC-to-DC converter 508 rectifies the AC energy signal received at the receive antenna 504 into a non-alternating power while the DC-to-DC converter 510 converts the rectified AC energy signal into an energy potential (e.g., voltage) that is compatible with the load 550. Various AC-to-DC converters are contemplated including partial and full rectifiers, regulators, bridges, doublers, as well as linear and switching converters.

The receive circuitry 502 may further include a matching circuit 512. The matching circuit 512 may comprise one or more resonant capacitors in either a shunt or a series configuration. In some implementations these resonant capacitors may tune the receive antenna to a specific frequency or to a specific frequency range (e.g., a resonant frequency).

The load 550 may be operably connected to the receive circuitry 502. The load 550 may be configured as the battery 236 as described above in reference to FIG. 2. In some implementations the load 550 may be external to the receive circuitry 502. In other implementations the load 550 may be integrated into the receive circuitry 502.

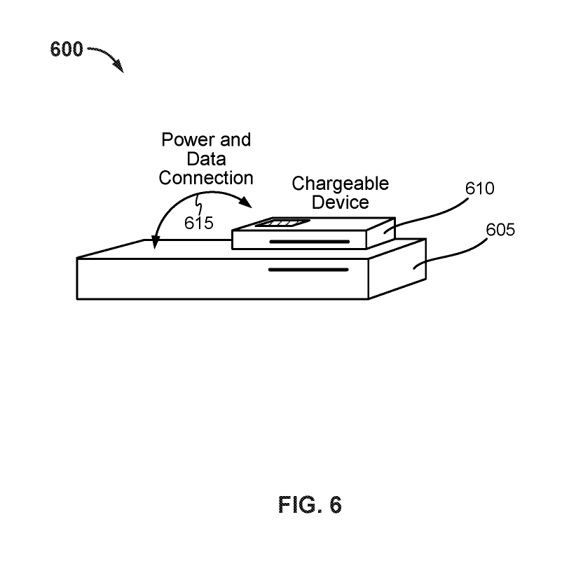

FIG. 6 is an example instance of a charging system 600 comprising an electronic device placed on a wireless power charger, in accordance with exemplary implementations of the invention. The electronic devices (chargeable devices) 610 and the wireless power charger (charging device) 605 may share a power and data transfer connection 615, in accordance with exemplary implementations of the invention. In some embodiments, the power and data transfer connection 615 may comprise independent power and data communication paths or protocols. For example, the power and data transfer connection 615 may comprise an NFC connection or separate wireless power transfer and Bluetooth communication connections. In some embodiments, the power and data transfer connection 615 may comprise combined power and data communication paths or protocols. For example, the power and data transfer connection 615 may comprise an in-band or back-scatter communication connection or a near field communication (NFC) or radio frequency identification power and communication connection. In some implementations, the power and data transfer connection 615 may comprise combined power and data communication paths or protocols. In some implementations, one of the chargeable devices 610 may comprise an antenna, a receiver circuit, and a load (integrated in the chargeable device 610) corresponding to the antenna 504, the receiver circuit 502, and the load 550 of FIG. 5, respectively. In some embodiments, the charging device 605 may comprise an antenna and a transmitter circuit (integrated in the charging device 605) corresponding to the antenna 404 and the transmitter circuit 402 of FIG. 4, respectively. The chargeable device 610 may be configured to receive power and send and/or receive data over the power and data connection 615 from the transmitter circuit of the charging device 605, and vice versa.

In some implementations, the chargeable device 610 may be within a charging region of the charging device 605 (e.g., placed on a charging surface of the charging device 605). When the charging device 605 is configured to charge other devices (e.g., in a charging mode), the charging device 605 may broadcast one or more beacon signals (“beacons”) to communicate with chargeable devices placed within its charging region. Additionally, these beacons (or other beacons broadcast by the charging device 605) may provide power to the chargeable device 610 within its charging region. These beacons may be used to communicate any necessary information (e.g., identification and detection of presence of charging device, charging parameters, charging details, device specifics, etc.) that may relate to the effective and safe charging of the chargeable device 610). In some implementations, examples of these parameters may include output current, output voltage, etc. These beacons may also provide power to the chargeable device 610 to allow the chargeable device 610 to be able to communicate with the charging device 605. For example, the chargeable device 610 may receive the power and/or communication beacon and communicate back to the charging device 605 via Bluetooth, near field communications (NFC), or another power transfer independent communication method or via back scattering or other in band communications.

In some embodiments, the chargeable device 610 may not receive sufficient power (i.e., an amplitude of an induced voltage at the chargeable devices may be too small) from the power/communication beacon broadcast by the charging device 605. This may be caused by low coupling between the charging device 605 and the chargeable device 610, for example, due the small size of the chargeable device 610 and/or their antennas. The small induced voltage may result in the chargeable device 610 having insufficient power to “boot” and enter a charging relationship with the charging device 605 (e.g., begin receiving charging power from the charging device 605). Accordingly, the chargeable device 610 may use power (i.e., the received power or power stored in the chargeable devices) to broadcast a long beacon extension (LBE) request to the charging device 605. The LBE request may comprise a request that a longer power/communication beacon be broadcast by the charging device 605 to provide the chargeable device 610 with sufficient energy to establish charging relationships as described herein.

In some implementations, the LBE request may simulate a pulsating large load at a given frequency and with a given amplitude (e.g., using one or more large and long power pulses). These simulated pulses may be generated as back scatter or in band signaling communications by the chargeable device 610 for the charging device 605 to identify. However, such pulses, which effectively change an impedance of the chargeable device 610 as seen by the charging device 605, may have specific requirements for the charging device 605 to be able to identify them as communications from the chargeable device 610. For example, to enable the charging device 605 to identify the power pulses as back scatter or in band signaling, the power pulses may need a power (amplitude) of at least 500 mW and a period of 10 ms with a duty cycle of 50% at the chargeable devices 610.

In some implementations, an amount of power that the chargeable device 610 receives from the beacon broadcast by the charging device 605 may be directly associated with a size of the receiving antenna of the chargeable device 610. Accordingly, when the chargeable device 610 (e.g., a wearable device or an implant, or other chargeable electronic device that may have an antenna with a size smaller than that of the transmitting antenna of the charging device 605) is placed within the charging area of the charging device 605, the chargeable device 610 may receive insufficient power via the beacon to communicate effectively with the charging device 605. In such a situation, when the chargeable device 610 is placed within the charging region of the charging device 605, the chargeable device 610 will not be charged by the charging device 605. Thus, the small chargeable device 610 including the receiver antenna that is smaller in size than the transmitting antenna of the charging device 605 may utilize another mechanism of generating the LBE and/or communicating with the charging device 605.

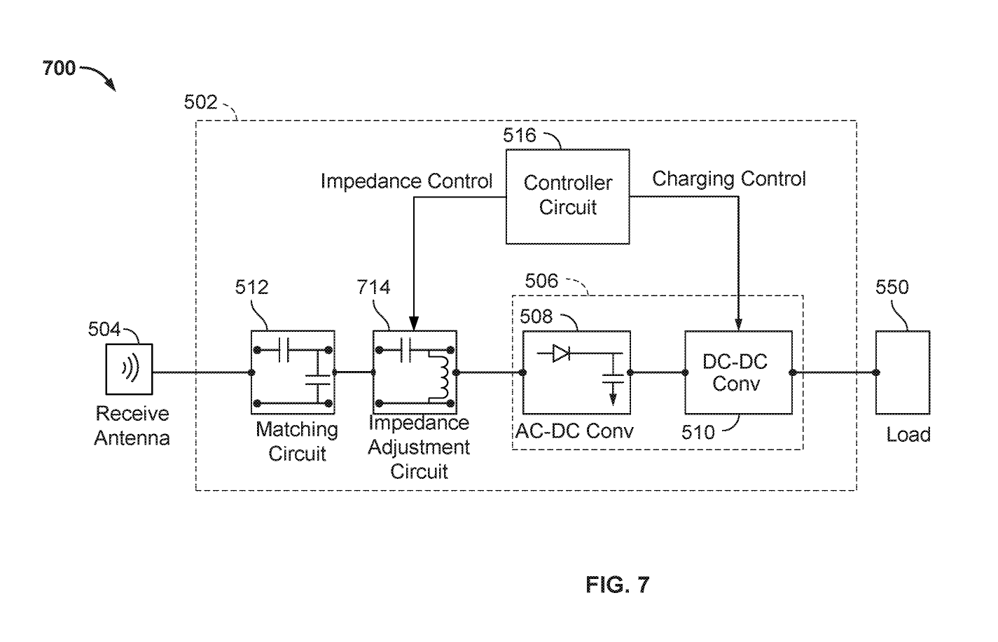

FIG. 7 is a simplified functional block diagram of a receiver 700 (corresponding to the receiver of the chargeable device 610 of FIG. 6) that is to receive wireless power from a field generated by the charging device (not shown) of FIG. 6, in accordance with exemplary implementations of the invention. The receiver 700 may include one or more of the components of the receiver 500 of FIG. 5. For example, the receiver 700 may include a receive antenna 504 coupled to an input of a receive circuitry 502, and the receive circuitry 502 coupled to an input of a load 550. The receive circuitry 502 may comprise the matching circuit 512, which is coupled to the receive antenna 504 and to an impedance adjustment circuit 714. The impedance adjustment circuit 714 is coupled to an input of the AC-DC converter of the power conversion circuit 506. The impedance adjustment circuit 714 may receive control signals from the controller circuit 516. The components in FIG. 7 corresponding to like components in FIG. 5 may comprise the same structures and functionality as the similarly numbered components of FIG. 5 and will not be described again here.

The impedance adjustment circuit 714 may comprise one or more components configured to adjust, tune, and/or modulate an impedance of the receiver 700. In some embodiments, the impedance adjustment circuit 714 may be integrated with one or more of the circuits of the receiver 700, such as the matching circuit 512.

The impedance (Z) of the receiver 700 is typically made up of two components: a resistance component (R, corresponding to a “real part” of the impedance, Z) and/or a reactance component (X, corresponding to an “imaginary part” of the impedance, Z). The impedance Z of the receiver 700 may be represented in of the resistance R and the reactance X components, as shown in Equation 1:

Z=R+jX (Equation 1)

The impedance adjustment circuit 714 may be configured to tune or modify the reactance component X of the impedance Z of the receiver 700, thereby varying the impedance Z of the receiver 700 as seen by the charging device 605 (of FIG. 6) generating the field to which the receiver 700 is exposed. In some embodiments, the impedance adjustment circuit 714 may further comprise one or more components configured to adjust or tune a resistance component R of the impedance Z of the receiver 700 as seen by the charging device 605. In some implementations, the impedance adjustment circuit 714 may comprise one or more of a capacitor and/or an inductor. In some embodiments, the capacitor may comprise a variable capacitor or a bank of switchable capacitors. Similarly, the inductor may comprise a variable inductor or a bank of switchable inductors. In some implementations, a “bank” of capacitors or inductors may comprise a collection of selectable capacitors or inductors, respectively.

The impedance adjustment circuit 714 may be operably coupled to the antenna 504, the controller 516, and the load 550 directly or via one or more other circuits. The controller 516 may be configured to control the one or more capacitors and/or inductors of the impedance adjustment circuit 714 to cause the reactance component X and/or the resistance component R of the receiver 700 to be changed and/or adjusted. These changes may generate the power pulses for communication by the receiver 700 to the charging device 605, as described herein. The change in the reactance component X of the impedance Z of the receiver 700 as seen by the charging device 605 may be more easily detectable by the charging device 605 than corresponding changes to the resistance component R. This may be because the reactance component X changes may detune a transmit circuit of the charging device 605. In other words, the charging device 605 may be more sensitive to changes in the reactance component X of the impedance Z of the receiver 700 as compared to changes in the resistance component R. Therefore, the reactance component X changes by the impedance adjustment circuit 714 may be result in shorter duration and/or lower power pulses by the receiver 700 as compared to corresponding power pulses due to resistance component R changes of the impedance Z of the receiver 700.

For example, when the impedance Z of the receiver 700 as seen by the charging device 605 is changed by modulating the resistance component R, the corresponding power pulses may need at least a 10 ms duration and a 50% duty cycle. However, when the impedance Z of the receiver 700 is changed by modulating the reactance component X, the corresponding power pulses may need only a 20 μs duration and less than a 50% duty cycle. In some aspects, the duty cycle may be greater than 50%. Accordingly, the duty cycle may be any value while the duration of the pulses is approximately 20 μs. Furthermore, the shorter duration pulses may result in less wasted power than the longer duration pulses of changes to the resistance component R of the impedance Z, as the power from the pulses is generally shunted to ground and/or through a dissipative component of the receiver 700, and thus lost as thermal energy.

Furthermore, when the impedance Z of the receiver 700 as seen by the charging device 605 is changed by modulating the resistance component R, the corresponding power pulses may need at least a 500 mV amplitude at the receiver 700. However, when the impedance Z of the receiver 700 is changed by modulating the reactance component X, the corresponding power pulses may need only an amplitude of less than 100 mV at the receiver 700. The reduced amplitude that still results in detection by the charging device 605 may also result in less wasted power, as less power is expended by the receiver 700 to generate the pulses that communicate with the charging device 605.

Furthermore, while communicating back to the charging device 605 for extending the long beacon using modulation of its reactance component X, the receiver 700 has to control the power to its output without (1) damaging the chargeable device 610, (2) dissipating too much power (e.g., as heat that may cause excessive power loss), or (3) losing excessive power to components of the receiver 700 (e.g., the load 650) that may utilize received power for various tasks. In some implementations, the excessive power dissipation may cause an increase in a temperature of the chargeable device 610 that could damage receiver 700 and the power lost to the power dissipation may not be available for more vital purposes.

The methods and apparatus described herein allow for the control of the output power of the receiver 700 while enabling the receiver 700 to participate in back scatter or in band signaling communications. In some implementations, the impedance adjustment circuit 714 may be configured to alternate between “capacitive” and “inductive” reactance component X changes as seen by the charging device 605. This may be accomplished by adjusting the impedance Z with the impedance adjustment circuit 714 to be above and/or below resonance by modulating the impedance Z with either the capacitive or the inductive reactance X. The resonance of the receiver 700 may occur when the capacitive and inductive reactances are equal in magnitude and cancel because they are 180 degree out of phase from each other (e.g., the capacitive reactance has a negative value corresponding to a positive inductive reactance value and the sum of both equals zero). The impedance Z may be increased by increasing the inductive reactance X, as the inductive reactance component of the impedance Z is positive. The impedance Z may be reduced by increasing the capacitive reactance X, as the capacitive reactance component of the impedance Z is negative. Thus, increasing the inductance reactance X may change the resonance of the receiver 700 to be above resonance while increasing the capacitive reactance X may change the resonance of the receiver 700 to be below resonance.

As described herein, power received by the receiver 700 may be maximized at resonance (e.g., when the capacitive and inductive reactances cancel). As the impedance increases (e.g., the impedance moves away from resonance), an amount of power received by the receiver 700 may drop. However, the power received by the receiver 700 may be controlled by detuning one or more components of the receiver 700. Thus, changes in the impedance may be compensated for by creating a positive reactance (via the inductive reactance) or a negative reactance (via the capacitive reactance). The power received by the receiver 700 versus the reactance of the receiver 700 shown as a graph (not shown) may have a bell shape where power received is maximized when the reactance is zero.

Such alternating between positive and negative reactance components X may allow the charging device 605 to more easily identify and/or detect impedance Z changes at the receiver 700. Thus, the receiver 700 may enable communications with the charging device 605 by maintaining a magnitude of impedance but changing the sign of the impedance via alternating the capacitive or inductive reactance component values. Additionally, the alternating between positive and negative reactance components X may further simplify the maintenance of output power by the receiver 700, which is especially advantageous in minimizing: (1) damage to the receiver 700 and/or the chargeable device 610, (2) excessive power dissipation, and/or (3) loss of power to the components of the receiver 700. Additionally, such alternating between positive and negative reactance components X may provide simplified communications between the receiver 700 and the charging device 605 during power transfer (e.g., charging of the chargeable device 610). The receiver 700 may maintain its output power at desired levels while switching between the capacitive and inductive reactance X modulations/variables to communicate zeros and ones to the charging device 605. The changing of the sign of the reflected reactance component X may be effected by jumping between positive and negative reactance component X values (corresponding to frequencies above and below resonance). For example, a positive reactance component X value causes the receiver 700 to effectively change its resonant frequency to be above the frequency at which the receiver 700 operates (for receiving power and/or communicating). Similarly, a negative reactance component X value causes the receiver 700 to effectively change its resonant frequency to be below the frequency at which the receiver 700 operates. In some implementations, maintaining the output power may comprise maintaining a level of power output to the load 550 to be within a desired threshold range, where the threshold range is either determined by the user or by design of the load 550, while changing the impedance of the receiver 700. In some implementations, the threshold range may include limits beyond which the load 550 will receive insufficient power to operate or may be damaged by the power levels received.

In some embodiments, the receiver 700 may further comprise a rectifier circuit (not shown) configured to modulate a phase displacement between a phase of a current of the receiver 700 and a phase of a voltage of the receiver 700. Modulation of a phase displacement may comprise movement of the phase of the current with regard to the phase of the voltage. In a synchronous rectifier, there is a defined phase between the current and voltage that pass through the rectifier. By using an appropriate rectifier circuit, the phase of the current with regard to the phase of the voltage may be varied or modulated. By changing the phase of the current with respect to the phase of the voltage, an amount of power output or transferred to a load may be varied. Additionally, this phase modulation may also be used to vary or modulate the impedance of the receiver 700 (both the resistance component R and the reactance component X). In some embodiments, the rectifier circuit may be used in combination with the impedance adjustment circuit 714 to adjust an impedance of the receiver 700 while maintaining a constant output to the load 550 of the receiver 700.

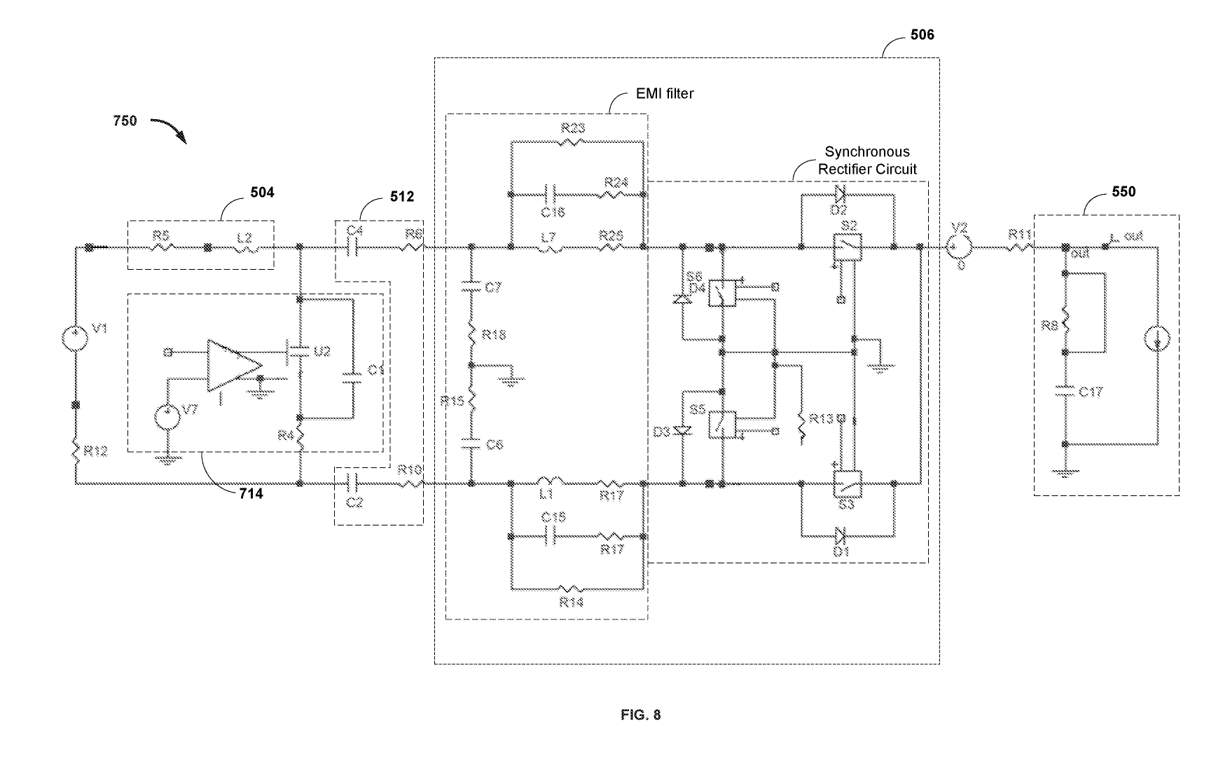

FIG. 8 is a schematic diagram 750 of the functional block diagram of the receiver 700 of FIG. 7, in accordance with exemplary implementations of the invention. Various components shown in the schematic 750 may correspond to one or more components of the receiver 700. For example, the resistor R5 and inductor L2 may correspond to the electrical schematic components that form the receive antenna (e.g., the receive antenna 504). The op amp, the capacitor C1 and the variable capacitor U2 may correspond to the impedance adjustment circuit 714 here configured to adjust capacitance. The circuit formed from the capacitor C4, resistor R6, capacitor C2, and the resistor R10 may correspond to a portion of a resonant tank (e.g., matching circuit 512). The components including C7, R18, R15, C6, L1, R17, C15, R16, R14, R23, C16, R24, L7, and R25 may correspond to an electromagnetic interference (EMI) filter (not shown). The components including D4, D3, S5, S6, D1, D2, S2, S3, and R13 may correspond to a full bridge synchronous rectifier circuit (not shown). The EMI filter and the full bridge synchronous rectifier circuit may be parts of the power conversion circuit 506. The portion of the circuit to the right of R11 may correspond to the load 550.

In some implementations, an additional inductor (not shown) may be included in the diagram 750. If the additional inductor is a variable inductor, then the additional inductor could contribute to the change of impedance by adding a variable inductive component, thus corresponding to the impedance adjustment circuit 714. However, the additional inductor may be lossy. In some implementations, the EMI filter may reduce harmonics generated by the rectifier (since it is a non-linear circuit) and may limit an effect of the harmonics on the receive antenna 504. In some implementations, the variable capacitor U2 may be replaced by a combined variable capacitance and variable inductance component or circuit.

Since the reactance component X changes from pulses of substantially less than 10 ms durations result in sufficiently large impedance Z variations as seen by the charging device 605, an output capacitor (e.g., capacitor C17) may be used to filter an output voltage. The output capacitor may be more efficient and less costly (with regard to component cost and circuit size/spacing). In some implementations, the output capacitor may function as an output regulator, or may be replaced by another component that functions as the output regulator. This is because the output voltage of the receiver 700 during the generated pulses stays within acceptable ranges of the receiver 700 without requiring a shunt regulator.

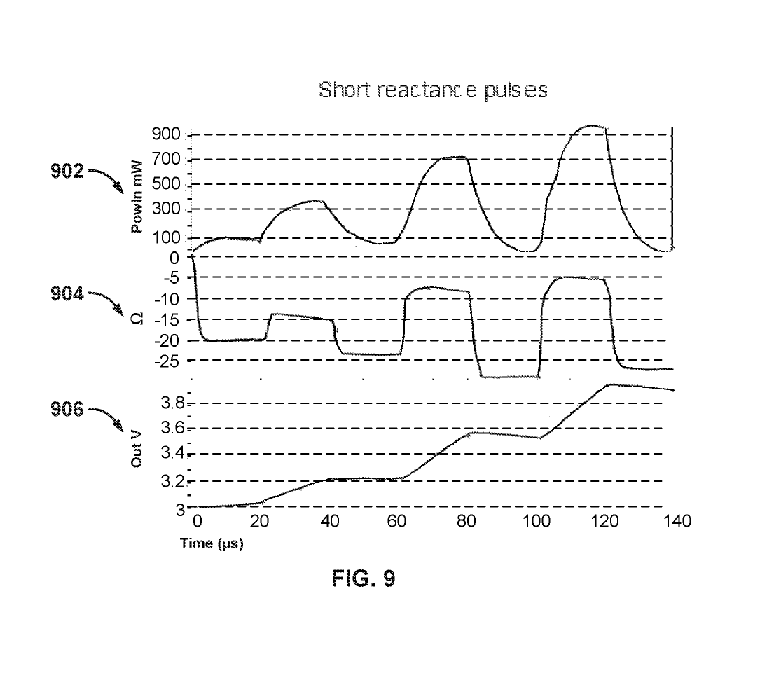

FIG. 9 is a set of three graphs 902, 904, 906 of an input power of the charging device 605 of FIG. 6 as a function of time, reactance X as seen by the charging device 605 as a function of time, and rectified voltage of the receiver 700 of FIG. 7 as a function of time, respectively, in accordance with exemplary implementations of the invention. Each of the graphs 902, 904, 906 shows time along the x-axis in microseconds (μs).

The first graph 902 shows input power of the charging device 605 as a function of time. Power is shown along the y-axis in milliwatts (mW) while time is shown along the x-axis in microseconds (μs). As shown, the input power of the charging device 605 approaches 100 mW between 0 and 20 μs and 40 μs and 60 μs. The input power of the charging device 605 approaches 0 mW between 80 μs and 100 μs and above approximately 120 μs. Between 20 μs and 40 μs, the graph 902 shows the input power of the charging device 605 as rising approximately 300 mW to approximately 400 mW. Between 60 μs and 80 μs, the graph 902 shows the input power of the charging device 605 as rising approximately 650 mW to approximately 750 mW. Between 100 μs and 120 μs, the graph 902 shows the input power of the charging device 605 as rising over 800 mW to approximately 1000 mW. Accordingly, the graph 902 shows the input power of the charging device 605 as it rises and falls corresponding to power pulses generated by the receiver 700.

The second graph 904 shows a reactance X of the receiver 700 as seen by the charging device 605, as a function of time. The reactance X is shown along the y-axis in Ω while time is shown along the x-axis in microseconds (μs). As shown, the reactance X seen by the charging device 605 approaches −20Ω between 0 and 20 μs. The reactance X seen by the charging device 605 approaches −24Ω between 40 and 60 μs. The reactance X seen by the charging device 605 approaches −30Ω between 80 and 100 μs. Between 20 and 40 μs, the graph 904 shows the reactance X as seen by the charging device 605 as it rises to and levels off at approximately −15Ω. Between 60 and 80 μs, the graph 904 shows the reactance X as seen by the charging device 605 as it rises to and levels off at approximately −7Ω. Between 100 and 120 μs, the graph 904 shows the reactance X as seen by the charging device 605 as it rises to and levels off at approximately −5Ω. Accordingly, the graph 904 shows that for each of the power pulses, the reactance X of the receiver 700 as seen by the charging device 605 increases according to the power received with the power pulses.

The third graph 906 shows a rectified voltage (Vrect) of the receiver 700, as a function of time. Vrect is shown along the y-axis in V while time is shown along the x-axis in microseconds (μs). The graph 906 shows the reactance X of the receiver 700 as seen by the charging device 605 as it rises and falls corresponding to pulses generated by the receiver 700. As shown, the Vrect of the receiver 700 remains level or decreases between 0 and 20 μs, 40 to 60 μs, 80 to 100 μs, and above 120 μs. Between 20 and 40 μs, the graph 906 shows the Vrect of the receiver 700 increasing from 3 to approximately 3.2 V. Between 60 and 80 μs, the graph 906 shows the Vrect the receiver 700 increasing from 3.2 V to approximately 3.6 V. Between 100 and 120 μs, the graph 906 shows the Vrect of the receiver 700 increasing from 3.55 V to approximately 4.0 V. Accordingly, the graph 906 shows that for each of the power pulses, the Vrect of the receiver 700 rises but stays below a critical value of 5.0 V.

When viewed together, the three graphs 902, 904, and 906 show that the short duration pulses (˜20 μs) generate reactance component X changes that are seen by the charging device 605 during the power pulses having magnitudes of between approximately 300 and 900 mV without the pulses exceeding the Vrect requirements of the receiver 700.

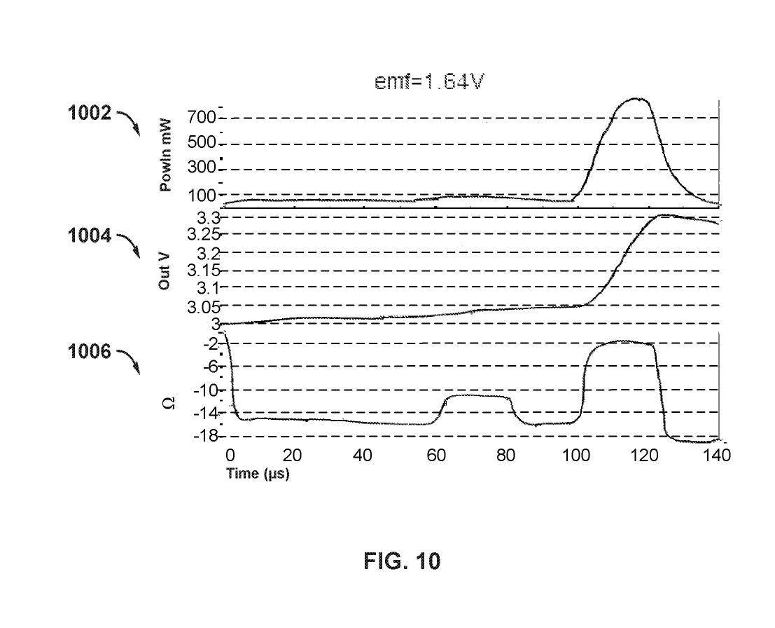

FIG. 10 is a set of three graphs 1002, 1004, 1006 of an input power of the charging device 605 of FIG. 6 as a function of time, reactance X as seen by the charging device 605 as a function of time, and rectified voltage of the receiver 700 of FIG. 7 as a function of time, respectively, in accordance with exemplary implementations of the invention. Each of the graphs 1002, 1004, 1006 show time along the x-axis in microseconds (μs).

The first graph 1002 shows input power of the charging device 605 as a function of time. The power is shown along the y-axis in milliwatts (mW) while time is shown along the x-axis in microseconds (μs); times described herein in relation to the figures may be approximate. The graph 1002 shows the input power of the charging device 605 as it rises and falls corresponding to power pulses generated by the receiver 700 (for example by a boost rectifier). As shown, in comparison with the graphs of FIG. 9, the boost rectifier may generate larger reactance pulses as seen by the charging device 605 with less power required at the receiver 700. In some implementations, the boost rectifier may correspond to the full bridge synchronous rectifier circuit shown in FIG. 8. As shown, the input power of the charging device 605 approaches 50 mW between 0 and 20 μs, between 40 μs and 60 μs, and between 80 and 100 μs. The input power of the charging device 605 approaches 0 mW above approximately 120 μs. Between 20 and 40 μs, the graph 1002 shows the input power of the charging device 605 as not rising substantially from approximately 50 mW. Between 60 and 80 μs, the graph 1002 shows the input power of the charging device 605 as rising to approximately 100 mW. Between 100 and 120 μs, the graph 1002 shows the input power of the charging device 605 as rising above approximately 800 mW. Accordingly, the graph 904 shows that for each of the power pulses, the reactance X of the receiver 700 as seen by the charging device 605 increases according to the power received with the power pulses.

The second graph 1004 shows a rectified voltage (Vrect) of the receiver 700, as a function of time. The rectified voltage is shown along the y-axis in volts (V) while time is shown along the x-axis in microseconds (μs). The graph 1004 shows the reactance X of the receiver 700 as seen by the charging device 605 as it rises and falls corresponding to pulses generated by the receiver 700. As shown, the Vrect of the receiver 700 remains approximately level between 0 and 20 μs, 40 to 60 μs, 80 to 100 μs, and above 120 μs. Between 20 and 40 μs, the graph 1004 shows the Vrect of the receiver 700 maintaining at approximately 3.02 V. Between 60 and 80 μs, the graph 1004 shows the Vrect the receiver 700 increasing from approximately 3.03 V to approximately 3.05 V. Between 100 and 120 μs, the graph 1004 shows the Vrect of the receiver 700 increasing from 3.05 V to approximately 3.3 V. Thus, the graph 1004 shows that for each of the power pulses, the Vrect rises at a less substantial rate than in FIG. 9 while still staying below a critical value of 5.0 V.

The third graph 1006 shows a reactance X of the receiver 700 as seen by the charging device 605, as a function of time. The reactance X is shown along the y-axis in S2 while time is shown along the x-axis in microseconds (μs). As shown, the reactance X seen by the charging device 605 approaches −15Ω between 0 and 20 μs, between 40 and 60 μs, and between 80 and 100 μs. Between 20 and 40 μs, the graph 1006 shows the reactance X as seen by the charging device 605 as it maintains at approximately −15Ω. Between 60 and 80 μs, the graph 1006 shows the reactance X as seen by the charging device 605 as it rises to and levels off at approximately −10Ω. Between 100 and 120 μs, the graph 1006 shows the reactance X as seen by the charging device 605 as it rises to and levels off at approximately −1.5Ω. Accordingly, the graph 1006 shows that for each of the power pulses, the reactance X of the receiver 700 as seen by the charging device 605 increases (e.g., approaches zero) in relation to the power received with the power pulses, because the power received by the receiver 700 increases as the reactance of the receiver 700 approaches zero.

When viewed together, the three graphs 1002, 1004, and 1006 show that the low amplitude modulated pulses generate reactance component X changes that are seen by the charging device without the pulses exceeding the Vrect requirements of the receiver 700.

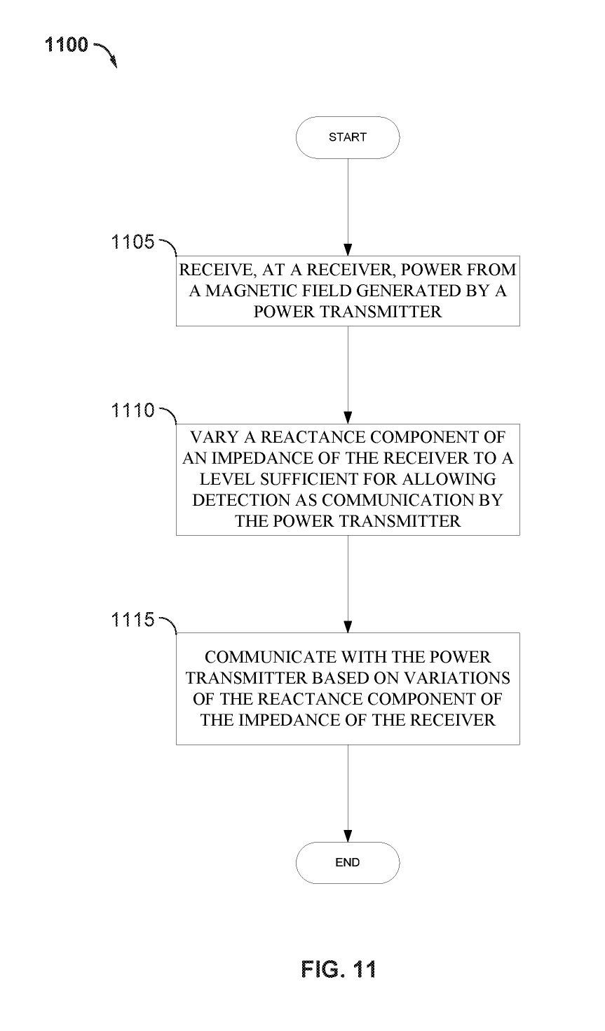

FIG. 11 is a flowchart includes a plurality of steps of a method 1100 of adjusting a reactance X of the receiver 700 of FIG. 7 as seen by the charging device 605 of FIG. 6 to a level sufficient for the charging device 605 to detect a reactance X change as an in-band communication, in accordance with exemplary implementations of the invention. For example, the method 1100 could be performed by the receiver 700 or the chargeable device 610 illustrated in FIG. 7 or FIG. 6, respectively. Method 1100 may also be performed by the receiver 500 (FIG. 5) in some aspects. A person having ordinary skill in the art will appreciate that the method 1100 may be implemented by other suitable devices and systems. Although the method 1100 is described herein with reference to a particular order, in various aspects, blocks herein may be performed in a different order, or omitted, and additional blocks may be added. Operation block 1105 includes receiving power from a magnetic field generated by the charging device 605 (e.g., a transmitter). In some implementations, as described herein, the power may be received from a beacon or from a dedicated power signal. Operation block 1110 includes varying a reactance component of an impedance of the receiver 700 to a level sufficient for allowing detection as communication by the charging device 605. Operation block 1115 includes communicating with the charging device 605 based on variations of the reactance component of the impedance of the receiver 700.

An apparatus for receiving wireless power may perform one or more of the functions of method 1100, in accordance with certain aspects described herein. The apparatus may be characterized by an impedance having a reactance component. The apparatus may comprise a means for receiving inductive power from a magnetic field generated by a power transmitter. In certain aspects, the means for receiving inductive power from a magnetic field generated by a power transmitter can be implemented by the receive antenna 504 (FIG. 5). In certain aspects, the means for receiving inductive power from a magnetic field generated by a power transmitter can be configured to perform the functions of block 1105 (FIG. 11). The apparatus may further comprise means for varying the reactance component of the impedance to a level sufficient for allowing detection of the varying as communication by the power transmitter. In certain aspects, the means for varying the reactance component of the impedance to a level sufficient for allowing detection of the varying as communication by the power transmitter can be implemented by the impedance adjustment circuit 714 or the synchronous rectifier or similar component capable of changing a reactance component of an impedance. In certain aspects, the means for varying the reactance component of the impedance to a level sufficient for allowing detection of the varying as communication by the power transmitter can be configured to perform the functions of block 1110 (FIG. 11). The apparatus may also comprise means for communicating with the power transmitter. In certain aspects, the means for communicating with the power transmitter r can be implemented by the receive antenna 504 or any other antenna of the apparatus. In certain aspects, the means for communicating with the power transmitter can be configured to perform the functions of block 1115 (FIG. 11).

In some embodiments, an apparatus for receiving wireless power may comprise, in some aspects, the receiver 700 and the receiver 700 may perform associated functions and methods described herein.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and method steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose hardware processor, a Digital Signal Processor (DSP), an Application Specified Integrated Circuit (ASIC), a Field Programmable Gate Array (FPGA) or other programmable logic device, discrete gate or transistor logic, discrete hardware components, or any combination thereof designed to perform the functions described herein. A general purpose hardware processor may be a microprocessor, but in the alternative, the hardware processor may be any conventional processor, controller, microcontroller, or state machine. A hardware processor may also be implemented as a combination of computing devices, e.g., a combination of a DSP and a microprocessor, a plurality of microprocessors, one or more microprocessors in conjunction with a DSP core, or any other such configuration.

The steps of a method and functions described in connection with the implementations disclosed herein may be embodied directly in hardware, in a software module executed by a hardware processor, or in a combination of the two. If implemented in software, the functions may be stored on or transmitted as one or more instructions or code on a tangible, non-transitory computer readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the hardware processor such that the hardware processor can read information from, and write information to, the storage medium. In the alternative, the storage medium may be integral to the hardware processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The hardware processor and the storage medium may reside in an ASIC.

For purposes of summarizing the disclosure, certain aspects, advantages and novel features s have been described herein. It is to be understood that not necessarily all such advantages may be achieved in accordance with any particular implementation. Thus, the present disclosure may be embodied or carried out in a manner that achieves or optimizes one advantage or group of advantages as taught herein without necessarily achieving other advantages as may be taught or suggested herein.

Various modifications of the above-described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. An apparatus for receiving wireless power, the apparatus characterized by an impedance having a reactance component, the apparatus comprising:
an antenna circuit configured to:
receive inductive power from a magnetic field generated by a power transmitter, and
communicate with the power transmitter; and
a control circuit coupled to the antenna circuit and configured to vary the reactance component of the impedance to a level sufficient for allowing detection as communication from the antenna circuit by the power transmitter.

2. The apparatus of claim 1, wherein the control circuit comprises at least one capacitor that reduces the reactance component and wherein the at least one capacitor comprises one of a variable capacitor and a capacitor bank.

3. The apparatus of claim 1, wherein the control circuit comprises at least one inductor that increases the reactance component and wherein the at least one inductor comprises one of a variable inductor and an inductor bank.

4. The apparatus of claim 1, further comprising a battery, wherein the control circuit is further configured to generate one or more pulses based at least in part on a configuration of the control circuit and one of the received power and a power stored in the battery.

5. The apparatus of claim 1, wherein the control circuit is further configured to generate one or more pulses having a duration of 20 microseconds and wherein the reactance component as changed by the control circuit is detectable by the power transmitter during the one or more pulses.

6. The apparatus of claim 1, wherein the control circuit is further configured to generate one or more pulses and adjust an amplitude of the one or more pulses by modulating a resistance component of the impedance of the apparatus as seen by the power transmitter.

7. The apparatus of claim 1, wherein the control circuit is further configured to generate one or more pulses having a duty cycle of less than 50% and wherein the reactance component as changed by the control circuit is detectable by the power transmitter during the one or more pulses.

8. The apparatus of claim 1, wherein the control circuit is further configured to generate one or more pulses based on an input power of less than 100 mV at the antenna circuit and wherein the reactance component as changed by the control circuit is detectable by the power transmitter during the one or more pulses.

9. The apparatus of claim 1, wherein the control circuit comprises one or more capacitors and one or more inductors and wherein the control circuit is further configured to alternate between capacitive and inductive adjustments to the reactance component.

10. The apparatus of claim 1, wherein the antenna circuit is further configured to communicate a long beacon extension request to the power transmitter via one or more pulses generated by the control circuit, wherein the one or more pulses effectively change the reactance component as seen by the power transmitter.

11. The apparatus of claim 1, wherein the control circuit is further configured to control an output power to a load to be below a desired threshold while adjusting the reactance component.

12. The apparatus of claim 1, further comprising an output regulator configured to output a power within a desired range.

13. The apparatus of claim 1, further comprising a rectifier configured to modulate a phase displacement between a phase of a voltage through the rectifier and a phase of a current through the rectifier and vary an amount of power transferred to a load of the apparatus while varying the impedance of the apparatus.

14. A method for receiving wireless power at an apparatus characterized by an impedance having a reactance component, the method comprising:
receiving inductive power from a magnetic field generated by a power transmitter;
varying the reactance component of the impedance to a level sufficient for allowing detection of the varying as communication by the power transmitter; and
communicating with the power transmitter.

15. The method of claim 14, further comprising reducing the reactance component via at least one capacitor, wherein the at least one capacitor comprises one of a variable capacitor and a capacitor bank.

16. The method of claim 14, further comprising increasing the reactance component via at least one inductor, wherein the at least one inductor comprises one of a variable inductor and an inductor bank.

17. The method of claim 14, further comprising generating one or more pulses based at least in part on a configuration of a control circuit of the apparatus and one of the received power and a power stored in a battery of the apparatus.

18. The method of claim 14, further comprising generating one or more pulses having a duration of 20 microseconds and wherein varying the reactance component is detectable by the power transmitter during the one or more pulses.

19. The method of claim 14, further comprising:
generating one or more pulses; and
adjusting an amplitude of the one or more pulses by modulating a resistance component of the impedance of the apparatus as seen by the power transmitter.

20. The method of claim 14, further comprising generating one or more pulses having a duty cycle of less than 50%, wherein varying the reactance component is detectable by the power transmitter during the one or more pulses.

21. The method of claim 14, further comprising generating one or more pulses based on an input power of less than 100 mV, wherein varying the reactance component is detectable by the power transmitter during the one or more pulses.

22. The method of claim 14, further comprising alternating between capacitive and inductive adjustments to the reactance component, wherein capacitive adjustments are performed by one or more capacitors and inductive adjustments are performed by one or more inductors.

23. The method of claim 14, further comprising communicating a long beacon extension request to the power transmitter via one or more pulses, wherein the one or more pulses effectively change the reactance component as seen by the power transmitter.

24. The method of claim 14, further comprising controlling an output power to a load to be below a desired threshold while adjusting the reactance component.

25. The method of claim 14, further comprising outputting a power within a desired range.

26. The method of claim 14, further comprising modulating a phase displacement between a phase of a voltage through a rectifier and a phase of a current through the rectifier and vary an amount of power transferred to a load of the apparatus while varying the impedance of the apparatus.

27. An apparatus for receiving wireless power, the apparatus characterized by an impedance having a reactance component, the apparatus comprising:
means for receiving inductive power from a magnetic field generated by a power transmitter;
means for varying the reactance component of the impedance to a level sufficient for allowing detection of the varying as communication by the power transmitter; and
means for communicating with the power transmitter.
